(19) United States
(12) Patent Application Publication
(10) Pub. No.: US 2014/0037449 A1
(43) Pub. Date: Feb. 6, 2014

(54) Power Plant for Obtaining Energy from a Flow of a Body of Water, and Method for the Operation Thereof

(71) Applicants: Norman Perner, Berlin (DE); Jochen Weilepp, Heidenheim (DE)

(72) Inventors: Norman Perner, Berlin (DE); Jochen Weilepp, Heidenheim (DE)

(21) Appl. No.: 13/985,865

(22) PCT Filed: Mar. 28, 2011
(86) PCT No.: PCT/EP2012/001061

§ 371 Date: Oct. 15, 2013

(30) Foreign Application Priority Data
Mar. 28, 2011 (DE) 10 2011 015 335.7

(51) Int. Cl. F03B 3/12

(52) U.S. Cl. CPC F03B 3/12
USPC 416/1; 416/9

(57) ABSTRACT

A power plant for obtaining energy from a flow of a body of water with a varying main incident flow direction, comprising a rotating unit with an axial turbine assigned an axis of rotation and comprises at least one rotor blade, the rotor blade is fastened in a rotationally conjoint manner to a rotor head of the rotating unit, and the rotor blade has at least over a partial region of the longitudinal extent thereof, a profile which can be impinged on by flow bidirectionally for windward and leeward operation. A rotary device is provided for a power plant component for adjusting a relative angle between the axis of rotation and the main flow direction, wherein the rotary device is assigned a first stop and a second stop which limit the range of movement of the rotary device to a range of angle of rotation of less than 180°.

The invention relates to a power plant according to the preamble of Claim 1 for obtaining energy from a current in a body of water having a varying main incident flow direction, in particular a tidal current, and a method for the operation thereof.

Various concepts have been proposed for adapting tidal power plants to a cyclic change of the incident flow direction in the course of ebb and flow. One possibility, which is described by GB 2347976 A, for example, is to fasten the rotor blades of an axial turbine on a hub so they are rotatable, and to execute a 180° rotation about the longitudinal axes of the rotor blades for the tide change. The advantage of this approach is that efficient rotor blade profiles designed for a unidirectional incident flow can be used. However, the blade angle adjustment mechanism increases the complexity of the rotor blade attachment. In addition, the controller for the blade angle setting must operate very reliably, since an incorrect incident flow can result in severe plant damage.

A further plant concept for tidal power plants, which allows the use of a rotor blade profile having unidirectional incident flow, for adaptation to the tide change consists of overall tracking of the components which mount the turbine. This is typically a nacelle having a mounting device for an axial turbine. The concept is known from wind power—reference is made as an example for this purpose to U.S. 2008/0111379 A1, wherein a rotational device for the nacelle of a tidal power plant must execute a rotation about 180°. The rotational drive used for this purpose can be produced electrically or hydraulically, for example. The use of an external drive in the form of a thruster, which initiates forces on a nacelle, is also conceivable—reference is made as an example for this purpose to U.S. 2010/0038911 A1. The use of a passively acting rotational device, for example, by means of a leeward arrangement of the axial turbine, is also conceivable. In the case of a windward design, as disclosed in KR 1020090116152 A, for example, fin-shaped flow guiding surfaces which lie on the leeward side are necessary to align the plant.

The known devices for overall tracking of an axial turbine for a tidal power plant allow either a rotational movement of the nacelle about a vertical axis or a rotation about an axis extending substantially horizontally. For the latter, reference is made to DE 10 2007 013 293 A1 and GB 2 431 207 A. For both configurations, the rotational device is assigned a rotational angle range of at least 180°, to allow the operation during incoming and outgoing tidal current.

A further plant concept for tidal power plants proceeds from a fixed location having rotor blades linked in a rotationally-fixed manner to an axial turbine. The adaptation to the tide change is caused by a profile of the rotor blades. Ellipsoidal profiles having double-axis symmetry can be used for this purpose. Reference is made to WO 2006/125959 A1 in this regard. Profiles having point symmetry and a bulge represent an alternative, so that the mean line follows a reflexed trailing edge—reference is made to U.S. 2007/0231148 A1 in this regard. The use of rotor blades linked in a rotationally-fixed manner having profiles which can have bidirectional incident flow results in robust and low-maintenance plants, since additional mounting and drive components for a rotational device used for tracking can be omitted.

The invention is based on the object of specifying a power plant for obtaining energy from a current in a body of water, the flow direction of which is variable with respect to time, which has the lowest-maintenance design possible. In addition, the power plant is to utilize a directionally-variable current in a body of water efficiently for obtaining energy, and simultaneously is to have a structurally simple speed regulation for the case of overload.

The object on which the invention is based is achieved by the features of the independent claims. According to the invention, a plant having an axial turbine which can have bidirectional incident flow, having rotor blades linked on in a rotationally-fixed manner, which has a profile which can have bidirectional incident flow for the combined windward and leeward operation, is combined with a rotational device, which does not permit complete directional reversal and instead only causes a partial rotation. Accordingly, the power plant operates in the cyclic change in windward and in leeward operation and the relative angle between the axis of rotation of the axial turbine and the main incident flow direction is only tracked in a limited rotational angle range of less than 180°, to compensate for the asymmetry of the tidal cycles or meteorologically-related incident flow variations. In addition, the rotational device for adapting the relative angle between axis of rotation and main incident flow direction causes a plant speed regulation in case of overload, in that the relative angle is guided to the maximum angular deviation, which is predefined by stops.

The rotational device has a first stop and a second stop for limiting the rotational angle to an angle range less than 180°. As a consequence, the control device can be structurally simplified, since an incorrect control of the rotational device cannot result in a fundamentally incorrect incident flow of the rotor designed for windward and leeward operation. Therefore, a failure of the rotational device does not endanger the entire plant.

In addition, a structural simplification of the drives and the mounting for the rotational device results from the partial rotation provided according to the invention in a rotational angle range less than 180°. The linear movement of a hydraulic cylinder can thus be used by means of a mechanical redirection for executing a rotation around a limited angle range. In addition, rudders and fins on the nacelle can be used to drive the rotational device, without these having a large protrusion length in the leeward direction, since due to the stops of the rotational device, the rotatable power plant components cannot stand entirely incorrectly with respect to the current due to the specification of a limited rotational angle range. In order to simplify the embodiment of the rotational drive as much as possible, the rotational angle range of the rotational device is composed as narrowly as possible and adapted to the translocation. For a preferred embodiment, the rotational angle range is less than 90° and particularly preferably less than 60°. Furthermore, the first and second stops are preferably set in accordance with the asymmetry of the tidal current at the plant location. For asymmetrical tidal ellipses having an angle deviation less than 30° of the 180° relative location for the average incident flow directions in the case of ebb, on the one hand, and flow, on the other hand, a rotational angle range less than 45° is advantageous, since the plant is tracked to the essential main incident flow directions and the rotational device can be embodied structurally simply.

For a preferred embodiment, the revolving unit is mounted with the axial turbine on a nacelle and the rotational device is arranged between the nacelle and the support structure. Accordingly, the power plant component which is moved by the rotational device within the predefined rotational angle range is the nacelle. The axis of rotation of the axial turbine is accordingly readjusted relative to the incident flow direction. A main incident flow direction which represents an average of the flow field in the rotor circuit of the axial turbine is assumed to be the incident flow direction.

One possible embodiment of the rotational device comprises an axis of rotation, which extends horizontally and is perpendicular to the axis of rotation of the axial turbine. For an embodiment having a nacelle and an axial turbine mounted thereon, the possibility thus exists of guiding the axis of rotation of the axial turbine away from the main incident flow direction by way of a limited tilting movement of the nacelle, to change the rotor characteristic curve for the plant speed regulation. An overload detection unit on the power plant, which is connected to a control unit for the rotational device, is preferably used for this purpose.

For efficient energy utilization at a location having an asymmetrical tidal ellipse, a rotational device having a vertically extending axis of rotation, which is perpendicular to the axis of rotation of the axial turbine, is preferred. This allows a weather-related variation of the main incident flow direction and location-specific directional deviations of an incoming or outgoing tidal current to be compensated for, which are caused by the relief on the floor of the body of water. For this purpose, the power plant comprises a flow measuring device for determining the presently provided main incident flow direction, which is connected to a control unit for the rotational device.

Distributed sensors and/or volume measuring methods are preferably applied for the flow measuring device, in order to detect or be able to estimate sufficiently precisely the flow conditions over the entire surface subtended by the rotor. A sonar, an ultrasound Doppler current profiler (ADCP), or a laser Doppler anemometer comes into consideration for this purpose. Furthermore, vortex flow meters, dynamic pressure pipes, differential pressure sensors, or indirect measuring systems such as strain gauges on the regions to which the current is applied may be used for measuring the flow field. The sensory components are preferably arranged around the plant or on fixed plant parts, such as the support structure. However, they may also be placed on plant components which are also moved, such as the hood of the rotor, the coupling attachment to the tower, or the nacelle.

Furthermore, the measured values are averaged on a timescale of several minutes and studied for the occurrence of current anomalies, such as the formation of vortices. In addition, a tidal model adapted to the location can be stored for controlling the rotational device. This is based on a tidal prediction, originating from a lunar calendar for the present location, which is refined by location-specific corrections. The location-specific corrections can be determined in operation from the accumulated measured data of the actual incident flow. Furthermore, it is conceivable to use data from the energy acquisition of the plant and the times at which the plant shutdown occurs to determine the correction factors. In addition, a control of the rotational device is conceivable, which aligns the plant in such a manner that the output power is optimized. An MPP controller can be used for this purpose.

For a refinement of the invention, a location change of the axis of rotation of the axial turbine relative to the fixed system does not occur by way of the rotational device. Instead, the rotational device is connected to a power plant component which is assigned to a flow housing enclosing the axial turbine. The starting point is accordingly a jacket turbine having an axial turbine enclosed by a flow housing. A movable implementation of the inflow and outflow regions of the flow housing is preferred, so that they are settable relative to a varying main incident flow direction. The rotation of the entire flow housing or pivoting of components of a guiding apparatus connected upstream or downstream of the axial turbine is also conceivable. According to the invention, the rotational angle for the respective power plant component is restricted to an angle range less than 180°, so that the through flow at the axial turbine reverses in the event of a tide change.

The invention will be explained in greater detail hereafter on the basis of exemplary embodiments in conjunction with illustrations in the figures; in the figures:

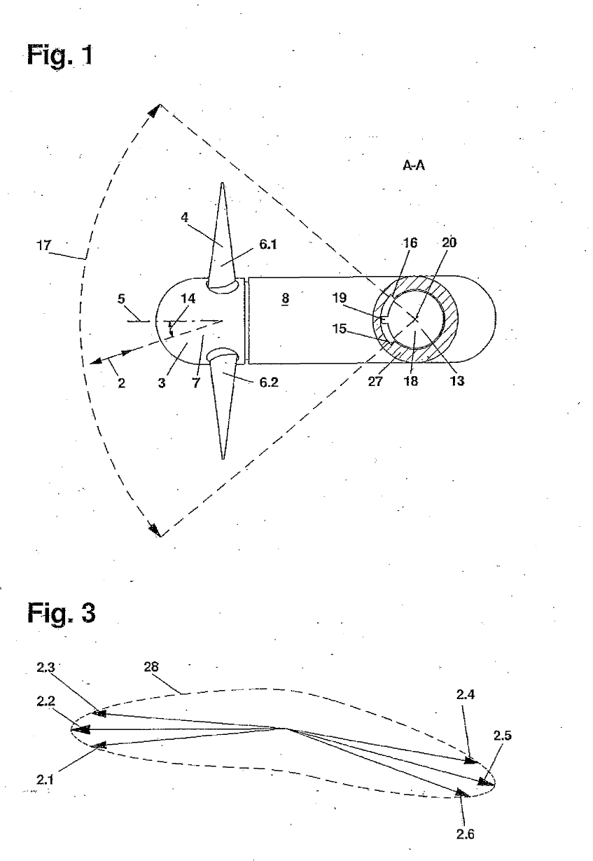

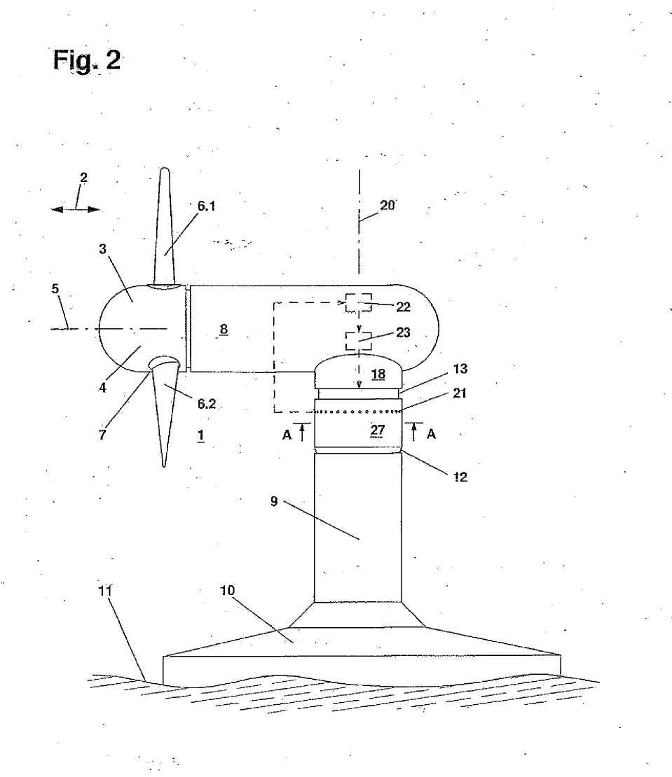

FIG. 1 shows a power plant according to the invention according to the sectional view A-A from FIG. 2.

FIG. 2 shows an exemplary embodiment of a power plant according to the invention in a side view.

FIG. 3 shows an asymmetrical tidal ellipse.

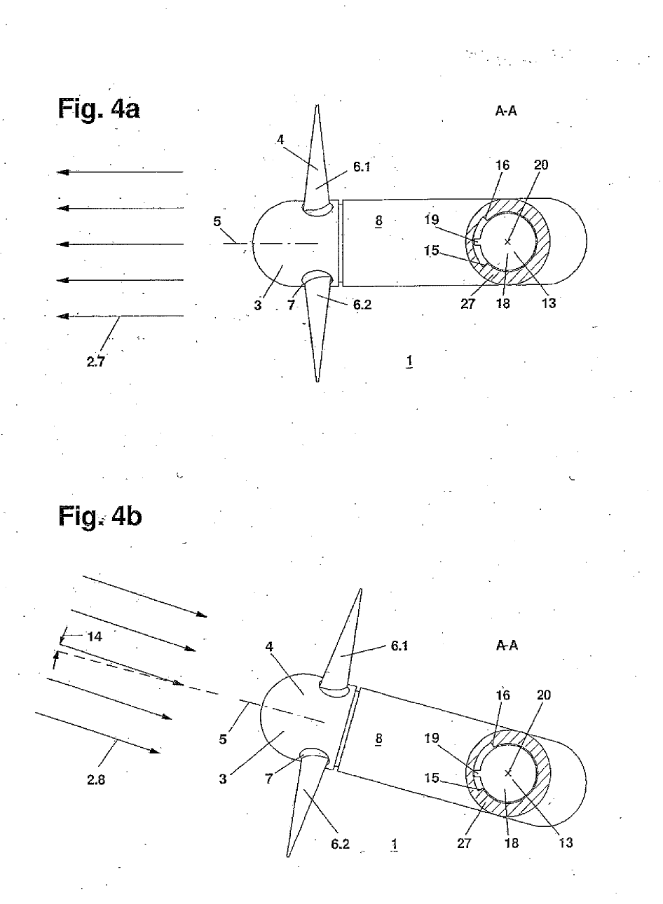

FIGS. 4a, 4b show the power plant from FIG. 1 for different incident flow conditions.

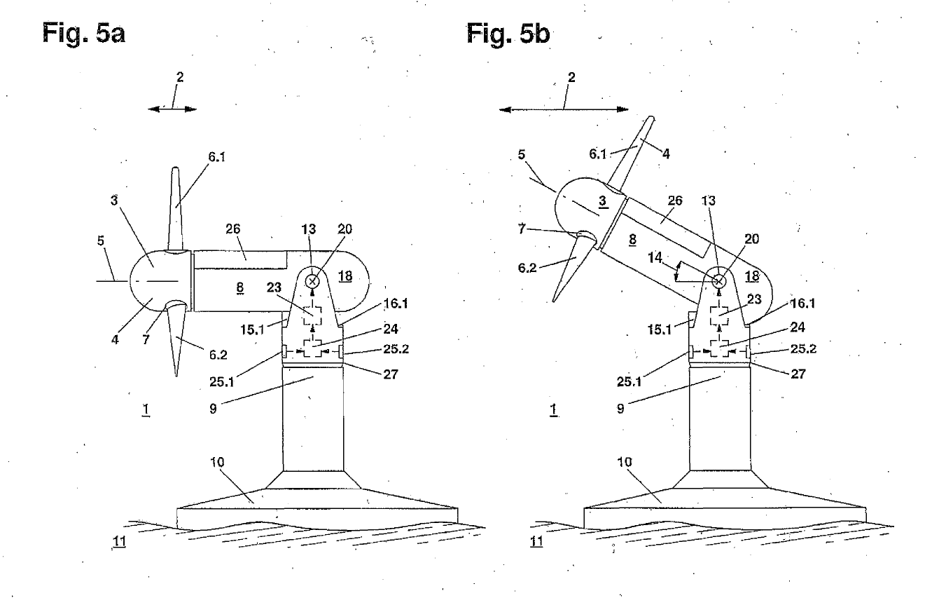

FIGS. 5a, b show an embodiment alternative of a power plant according to the invention in a side view in normal operation and in overload position.

FIG. 2 shows in schematically simplified form a power plant according to the invention in a side view. An axial turbine 4 mounted on a nacelle 8 is shown. The axial turbine 4 has a horizontal axis of rotation 5, which is aligned parallel to the main incident flow direction 2. The main incident flow direction 2 represents a speed-weighted averaging of the incident flow in the region which is established by the rotor circle of the axial turbine 4.

As indicated by the double arrow, a varying main incident flow 2 is provided in the meaning of a cyclic change of the tidal direction, which drives the axial turbine 4 alternately in windward and leeward operation. The rotor blades 6.1, 6.2, which are fastened in a rotationally fixed manner on a rotor head 7 of the revolving unit 3 of the axial turbine 4, are accordingly designed as rotor blades 6.1, 6.2 which can have bidirectional incident flow. The profile, which can have bidirectional incident flow, required for this purpose, typically a double-axis symmetrical or reflexed trailing edge profile, is drawn over at least a subregion of the longitudinal extension of the blade.

According to the invention, for a plant designed for combined windward and leeward operation, an additional rotational device 13 is provided, which allows a partial rotation of the nacelle 8. The rotation occurs about the plant vertical axis, which presently forms the axis of rotation 20. As shown, the interface between the rotating part 18 of the plant and the fixed part 27 is located on a tower adapter on the nacelle 8, which is placed on a coupling device 12 on a support element 9. The support element 9 rests on a foundation part 10, by which the support on the body of water floor 11 is produced.

Furthermore, FIG. 2 outlines a flow measuring device 21 on the fixed part 27, which is used to detect the main incident flow direction 2. The measuring signals are transmitted to a control unit 22, which is provided for controlling and/or regulating the rotational drive 23 for the rotational device 13.

FIG. 1 shows the section A-A from FIG. 2, wherein only the rotational angle limiting unit is shown in simplified form to illustrate the rotational device 13. A first stop 15 and a second stop 16 on the fixed part 27 are shown. These cooperate with a projection 19 on the rotating part to delimit a rotational angle range 17 for the rotational device 13. For the present embodiment, a rotational angle range 17 of 90° about the axis of rotation 20 results for the nacelle 8. Plant tracking within the rotational angle range 17 can be executed by a rotational drive (not shown in detail in FIG. 1).

The main incident flow direction 2 outlined in FIG. 1 shows, for a windward or leeward incident flow, a relative angle 14 to the axis of rotation 5 of the axial turbine 4, which can be reduced by the rotational device 13. Such variations of the main incident flow direction 2, which can occur for tides at specific plant locations, are shown in FIG. 3—an asymmetrical tidal ellipse is illustrated. The main incident flow direction can vary within a tidal phase because of location-specific conditions or as a result of weather influences. This is shown in FIG. 3 on the basis of the main incident flow directions 2.1, 2.2, 2.3 for the flow phase and the main incident flow directions 2.4, 2.5, 2.6 for the ebb phase. Furthermore, it is apparent that the parts of the tidal ellipse assigned to the ebb and the flow are not applied symmetrically, wherein such a current characteristic results from the relief present on the body of water flow and the course of the coastline and the islands or marine structures upstream or downstream of the location.

FIGS. 4a and 4b shows the plant position for two different incident flow situations. In FIG. 4a, the present main incident flow direction 2.7 results in a leeward operation of the plant, as shown, the axis of rotation 5 and the main incident flow direction 2.7 extend in parallel. FIG. 2.8 shows the power plant 1 in windward operation and a setting tracked by the rotational device 13. A relative angle 14 exists between the axis of rotation 5 and the main incident flow direction 2.8. This is preferably corrected on a timescale of several minutes by the rotational device 13, wherein averaging with respect to time and filtering for the measured data of the main incident flow direction 2.8 are used.

A simplified embodiment of the invention is outlined in FIGS. 5a, 5b. A power plant according to the invention is shown in a side view in two different operating positions. In the present case, the rotational device 13 has a horizontally extending axis of rotation 20.2, which allows a tilting movement of the nacelle 8 on the tower adapter, which forms the fixed part 27. In FIG. 5a, the nacelle 8 presses against a first stop 15.1 of the rotational device 13 and is located in the operating position. An alternating main incident flow direction 2 is indicated, which results in a bidirectional incident flow on the axial turbine 4 and a combined windward and leeward operation.

By means of an overload detection unit 24, which is connected to the overload sensors 25.1, 25.2, the flow field is measured. In the case of a main incident flow direction 2, the speed of which is greater than a fixed threshold value, to relieve the axial turbine 4, a tilting movement of the nacelle 8 about the axis of rotation 20 is caused until a second stop 16.1 is reached. This operating position, which is shown in FIG. 5a, results in a diagonal incident flow, which reduces the loads on the rotor blades 6.1, 6.2. The load reduction is based on a reduction in size of the projection surface of the rotor circle on a plane perpendicular to the main incident flow direction 2. Furthermore, the diagonal incident flow results in a change of the rotor characteristic curve, which changes the power consumption and the rotor loads. The relative angle 14 between the axis of rotation 5 and the main incident flow direction 2, which is set for this embodiment for facility speed regulation by the rotational device 13, corresponds to the rotational angle range fixed by the location of the first stop 15.1 and the second stop 16.1, which is less than 45° in the present case.

To transfer the nacelle 8 from the operating position shown in FIG. 5a to the speed-regulated position illustrated in FIG. 5b, a buoyancy tank 26 in the nacelle 8 can be used. A positive buoyancy, which rotates the nacelle 8 together with the axial turbine 4 into the partially upright position shown in FIG. 5b, arises due to the blowing out of the buoyancy tank 26. The erecting torque must be sufficiently large that the dynamic pressure of a leeward incident flow also does not return the nacelle 8 to the first stop 15.1. Further embodiments of the invention result from the following claims for protection.

### LIST OF REFERENCE NUMERALS

1 power plant

2, 2.1, . . . , 2.8 main incident flow direction

3 revolving unit

4 axial turbine

5 axis of rotation

6.1, 6.2 rotor blade

7 rotor head

8 nacelle

9 support element

10 foundation part

11 body of water floor

12 coupling device

13 rotational device

14 relative angle

15, 15.1 first stop

16, 16.1 second stop

17 rotational angle range

18 rotating part

19 projection

20, 20.2 axis of rotation

21 flow measuring device

22 control unit

23 rotational drive

24 overload detection unit

25.1, 25.2 overload sensors

26 buoyancy tank

27 fixed part

28 tidal ellipse

1-9. (canceled)

10. A power plant for obtaining energy from a current in a body of water having a varying main incident flow direction, the power plant comprising:
a revolving unit having an axial turbine, to which an axis of rotation is assigned and which comprises at least one rotor blade;
wherein the rotor blade is fastened in a rotationally-fixed manner on a rotor head of the revolving unit;
wherein the rotor blade has a profile which can have bidirectional incident flow for windward and leeward operation over at least a subregion of its longitudinal extension; and
wherein a rotational device is provided for a power plant component for setting a relative angle between the axis of rotation and the main incident flow direction, wherein a first stop and a second stop are assigned to the rotational device, which stops restrict the movement range of the rotational device to a rotational angle range less than 180°.

11. The power plant according to claim 10, wherein the revolving unit is mounted on a nacelle, which is borne by a support element, wherein the rotational device is arranged between the nacelle and the support element.

12. The power plant according to claim 11, wherein the rotational device comprises an axis of rotation, which extends horizontally and which is perpendicular to the axis of rotation of the axial turbine.

13. The power plant according to claim 11, wherein the rotational device comprises an axis of rotation, which extends vertically and is perpendicular to the axis of rotation of the axial turbine.

14. The power plant according to claim 10, wherein the axial turbine has the body of water current flow around it freely and the rotational device is applied such that the location of the axis of rotation is settable within the rotational angle range.

15. The power plant according to claim 11, wherein the axial turbine has the body of water current flow around it freely and the rotational device is applied such that the location of the axis of rotation is settable within the rotational angle range.

16. The power plant according to claim 12, wherein the axial turbine has the body of water current flow around it freely and the rotational device is applied such that the location of the axis of rotation is settable within the rotational angle range.

17. The power plant according to claim 13, wherein the axial turbine has the body of water current flow around it freely and the rotational device is applied such that the location of the axis of rotation is settable within the rotational angle range.

18. The power plant according to claim 10, wherein the axial turbine is enclosed by a flow housing and the rotational device is designed such that the location of at least one flow housing component is settable.

19. The power plant according to claim 11, wherein the axial turbine is enclosed by a flow housing and the rotational device is designed such that the location of at least one flow housing component is settable.

20. The power plant according to claim 12, wherein the axial turbine is enclosed by a flow housing and the rotational device is designed such that the location of at least one flow housing component is settable.

21. The power plant according to claim 13, wherein the axial turbine is enclosed by a flow housing and the rotational device is designed such that the location of at least one flow housing component is settable.

22. The power plant according to claim 10, wherein the power plant comprises a flow measuring device for determining the main incident flow direction, which is connected to a control unit for the rotational device.

23. The power plant according to claim 11, wherein the power plant comprises a flow measuring device for determining the main incident flow direction, which is connected to a control unit for the rotational device.

24. The power plant according to claim 12, wherein the power plant comprises a flow measuring device for determining the main incident flow direction, which is connected to a control unit for the rotational device.

25. The power plant according to claim 13, wherein the power plant comprises a flow measuring device for determining the main incident flow direction, which is connected to a control unit for the rotational device.

26. The power plant according to claim 10, wherein the power plant comprises an overload detection unit, which is connected to a control unit for the rotational device.

27. The power plant according to claim 11, wherein the power plant comprises an overload detection unit, which is connected to a control unit for the rotational device.

28. The power plant according to claim 12, wherein the power plant comprises an overload detection unit, which is connected to a control unit for the rotational device.

29. A method for operating a power plant for obtaining energy from a current in a body of water having a varying main incident flow direction having a revolving unit having an axial turbine, to which an axis of rotation is assigned and which comprises at least one rotor blade; wherein the rotor blade is fastened in a rotationally-fixed manner on a rotor head of the revolving unit, and wherein the rotor blade has a profile which can have bidirectional incident flow for windward and leeward operation over at least a subregion of its longitudinal extension, the method comprising:
setting a relative angle between axis of rotation and the main incident flow direction by means of a rotational device, to which a first stop and a second stop are assigned, wherein the setting of the relative angle is executed in a rotational angle range, which is restricted by the first stop and the second stop to an angle range less than 180°.
